(19) United States
(12) Patent Application Publication
(10) Pub. No.: US 2012/0303964 A1
(43) Pub. Date: Nov. 29, 2012

(54) PORTABLE TERMINAL, AND METHOD FOR SECURING DATA TRANSMITTED BETWEEN HARDWARE MODULES

(75) Inventor: Kwang Baek KIM, Seoul (KR)

(73) Assignee: PANTECH CO., LTD., Seoul (KR)

(21) Appl. No.: 13/332,116

(22) Filed: Dec. 20, 2011

(30) Foreign Application Priority Data
May 27, 2011 (KR) 10-2011-0050565

(51) Int. Cl. H04L 9/32; H04L 9/00

(52) U.S. Cl. 713/182; 713/189

(57) ABSTRACT

Provided are a portable terminal and a method for securing data transmitted between hardware modules of the portable terminal. The portable terminal may include an input module to encrypt input data, using a first secure key, if the portable terminal operates in a secure mode, and a processing module to receive the data, and to decrypt the user input data encrypted using the first secure key, using a second secure key, the first key and the second key being a pair.

### CROSS-REFERENCE TO RELATED APPLICATION

This application claims priority from and the benefit under 35 U.S.C. §119(a) of Korean Patent Application No. 10-2011-0050565, filed on May 27, 2011, which is hereby incorporated by reference for all purposes as if fully set forth herein. This application is related to U.S. patent application Ser. No. ______, filed on ______, having attorney docket number P4592US00 which claims priority from and the benefit of Korean Patent Application No. 10-2011-0035869, filed on Apr. 18, 2011, and U.S. patent application Ser. No. ______, filed on ______, having attorney docket number P4593US00 which claims priority from and the benefit of Korean Patent Application No. No. 10-2011-0035866, filed on Apr. 18, 2011, all of which are assigned to the same assignee as the current application, and all of which are incorporated by reference in its entirety as if fully set forth herein.

### BACKGROUND

1. Field

This disclosure relates to a method for securing data transmitted between hardware modules of a portable terminal, wherein the portable terminal is at least one of: a smart phone, a tablet personal computer (PC), a multimedia device, and the like.

2. Discussion of the Background

Applications requiring heightened security protection, such as financial programs, are implemented and used with various electronic devices and mobile terminals, such as smart phones, tablet personal computers (PC), and the like. However, the applications may be vulnerable to hacking. Specifically, for example, an electronic device using an open source operating system (OS) may be vulnerable to hacking.

A secure method using a virtual keyboard provided on a web server may be used to reduce a possibility of a hacking attack. However, the secure method using the virtual keyboard may, while accessing a web server, be vulnerable to hacking against electronic devices.

Thus, in the above enumerated situations and devices, data transmitted between hardware modules within a portable terminal may not be secured and protected from hacking.

### SUMMARY

Exemplary embodiments of the present invention provide an apparatus and method for securing data transmitted between various hardware modules that may be associated or within a portable terminal. Thus, this may reinforce a security of a portable terminal by providing encrypted data that is transmitted between hardware modules of the portable terminal.

Additional features of the invention will be set forth in the description which follows, and in part will be apparent from the description, or may be learned by practice of the invention.

An exemplary embodiment provides a portable terminal, including: an input module to receive an input and to encrypt the input based on a mode of operation of the portable terminal; a main processor to control the portable terminal and to determine the mode as a secure mode or a non-secure mode; and a processing module to decrypt the input in the secure mode, wherein the processing module connects to the main processor and the processing module, and provides the decrypted input to the main processor or the input module.

An exemplary embodiment provides a method for securing data for a portable terminal, the method including: receiving an input and encrypting the input based on a mode, in an input module; controlling the portable terminal and determine the mode as a secure mode or a non-secure mode, in a main processor; decrypting the input in the secure mode, in a processor module connected to the main processor; and providing the decrypted input to the main processor or the input module.

An exemplary embodiment provides a portable terminal, including: an input module to receive an input and to encrypt the input based on a mode of operation of the portable terminal; a main processor to control the portable terminal, to decrypt the input based on an encryption key, and to determine the mode as a secure mode or a non-secure mode; and an authentication server to receive an encryption key request and to provide the encryption key to the main processor, wherein the authentication server connects to the main processor and the input module.

It is to be understood that both the foregoing general description and the following detailed description are exemplary and explanatory and are intended to provide further explanation of the invention as claimed. Other features and aspects will be apparent from the following detailed description, the drawings, and the claims.

### BRIEF DESCRIPTION OF THE DRAWINGS

The accompanying drawings, which are included to provide a further understanding of the invention and are incorporated in and constitute a part of this specification, illustrate embodiments of the invention, and together with the description serve to explain the principles of the invention.

FIG. 1A is a block diagram illustrating an exemplary embodiment of the present invention.

FIG. 1B is a block diagram illustrating a portable terminal according to an exemplary embodiment of the present invention.

FIG. 2 is a block diagram illustrating a portable terminal according to an exemplary embodiment of the present invention.

FIG. 3 is a diagram illustrating a method for securing data transmitted between hardware modules according to an exemplary embodiment of the present invention.

FIG. 4 is a diagram illustrating a method for securing data transmitted between hardware modules according to an exemplary embodiment of the present invention.

FIG. 5 is a diagram illustrating a method for processing associated with an authentication certificate according to an exemplary embodiment of the present invention.

FIG. 6 is a diagram illustrating a method for operating a processing module according to an exemplary embodiment of the present invention.

FIG. 7 is a diagram illustrating a method for performing processing according to an exemplary embodiment of the present invention.

FIG. 8 is a diagram illustrating a method of transmitting a packet according to an exemplary embodiment of the present invention.

FIG. 9 is a diagram illustrating a secure mode operation of a touch integrated circuit (IC) according to an exemplary embodiment of the present invention.

FIG. 10 is a diagram illustrating a secure mode operation of a touch IC according to an exemplary embodiment of the present invention.

FIG. 11 is a diagram illustrating a secure mode operation of a touch IC according to an exemplary embodiment of the present invention.

FIG. 12 is a diagram illustrating a secure mode operation of a touch IC according to an exemplary embodiment of the present invention.

FIG. 13 is a diagram illustrating a method for displaying an input interface on a touch panel according to an exemplary embodiment.

FIG. 14 is a diagram illustrating a method for obtaining an encryption key according to an exemplary embodiment of the present invention.

### DETAILED DESCRIPTION OF THE ILLUSTRATED EMBODIMENTS

It will be understood that when an element is referred to as being “connected to” another element, it can be directly connected to the other element, or intervening elements may be present.

Exemplary embodiments are described more fully hereinafter with reference to the accompanying drawings, in which embodiments of the invention are shown. This invention may, however, be embodied in many different forms and should not be construed as limited to the embodiments set forth herein. Rather, these embodiments are provided so that this disclosure is thorough, and will fully convey the scope of the invention to those skilled in the art. It will be understood that for the purposes of this disclosure, “at least one of X, Y, and Z” can be construed as X only, Y only, Z only, or any combination of two or more items X, Y, and Z (e.g., XYZ, XZ, XYY, YZ, ZZ). Further, it will be understood that when an element is referred to as being “connected to” another element, it can be directly connected to the other element, or intervening elements may be present. In contrast, if an element is referred to as being “directly connected to” another element, no intervening elements are present. Throughout the drawings and the detailed description, unless otherwise described, the same drawing reference numerals are understood to refer to the same elements, features, and structures. The relative size and depiction of these elements may be exaggerated for clarity, illustration, and convenience.

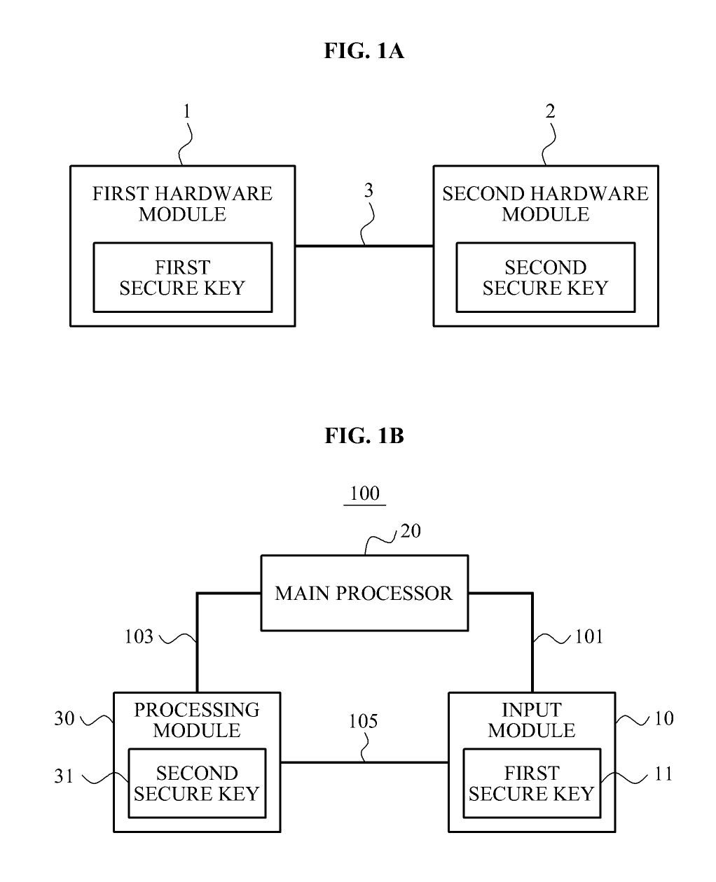

FIG. 1A is a block diagram illustrating an exemplary embodiment of the present invention.

Referring to FIG. 1A, a first hardware module 1 encrypts, using a first secure key, data transmitted from the first hardware module 1 to a second hardware module 2, and the second hardware module 2 decrypts data encrypted using the first secure key, using a second secure key. In FIG. 1, line 3 indicates a data transmission path between the first hardware module 1 and the second hardware module 2. Here, the first secure key and the second secure key may constitute a pair. In this case, the pair relationship may indicate the first secure key and the second secure key have a same or similar key value, a symmetric key relationship, or an asymmetric key relationship.

If operating in a secure mode, the first hardware module may prompt for a password or any other security technique along with or as input data, and may encrypt the input data using the first secure key. Here, the input data may indicate data that is input to the first hardware module 1.

The second hardware module 2 may receive the input data encrypted using the first secure key in the secure mode, may decrypt the input data that has been encrypted using the second secure key, and may perform processing using the decrypted user input data. Here, the processing may be determined based on a type of the second hardware module 2.

The first hardware module 1 may be a hardware module that receives user input or may be a communication module that receives data from an outside source over a communication network. The input data may be provided by a user or an apparatus communicating with the first hardware module 1. However, for the simplicity in disclosure, inputs provided by the user or the apparatus may be referred to as “user input” or simply “input”. A type of the hardware module is not limited thereto. If the first hardware module 1 corresponds to an input module, the second hardware module 2 may correspond to a processing module for processing the user input data. For example, the processing module may include a universal subscriber identity module (USIM) chip, a display module, a touch integrated circuit (IC), and the like. For example, the communication module may encrypt received data and transmit the encrypted data to a display module. The display module may decrypt the encrypted data and display the decrypted data. In addition, various operations may be performed depending on the operation of the first hardware module 1 and the second hardware module 2, which will be described throughout this disclosure.

At least one of the first secure key and the second secure key may be a unique key that is allocated in production of the first hardware module 1 or the second hardware module 2, or when initially mounting the first hardware module 1 or the second hardware module 2, to a portable terminal. Also, after the first secure key and the second secure key are stored in the first hardware module 1 in production of the hardware module 1, the second secure key may be transferred to the second hardware module 2.

Hereinafter, data encrypted using a key for encryption is expressed herein in a format of “data\textcircled{X}key”. For example, a user inputted data encrypted using the first secure key may be expressed as “user input data\textcircled{X}first secure key”.

FIG. 1B is a block diagram illustrating a portable terminal according to an exemplary embodiment of the present invention.

Referring to FIG. 1B, the portable terminal 100 may include an input module 10, a main processor 20, and a processing module 30. If the portable terminal 100 operates in a secure mode, all or some, of the data transmitted and received among data transmission paths 101, 103, and 105 may correspond to the encrypted data. The data transmission paths 101, 103, and 105 may be physical lines and thus, important data in the data transmission paths 101, 103, and 105 may be protected. Here, the secure mode indicates a mode that incorporates security along with a user input data. Hardware modules, such as the input module 10 and the processing module 30, may include an integrated circuit (IC) capable of performing an encryption algorithm.

The input module 10 may be a hardware module that receives a manipulation of the user, or any other type of inputted data, on the portable terminal 100. Herein, the user input data indicates data produced due to manipulation by a user on the portable terminal 100. However, inputted data may be sourced from other sources as well as a user. For example, the manipulation by the user may include various types of touches on a touch panel, pushing of a keypad, a gesture, a button manipulation, waving or moving the portable terminal 100 in a reference direction, and the like. Accordingly, the input module 10 may include a touch panel and a touch IC. Also, the input module 10 may include a keypad, a motion sensor, a camera, various buttons, a gyro sensor, a magnetic sensor, and the like.

If the portable terminal 100 operates in the secure mode, the input module 10 may encrypt the user input data using a first secure key. If the portable terminal 100 operates in a non-secure mode, the input module 10 may not encrypt the user input data. The input module 10 may store a first secure key 11. In the secure mode, the input module 10 may encrypt user data that is input into the portable terminal 100, using the first secure key 11. Here, the first secure key 11 indicates a unique key allocated in production of the input module 10, or if the input module 10 is mounted to the portable terminal 100. Accordingly, data encrypted using the first secure key 11 may be decrypted using a second secure key 31 that constitutes a pair with the first secure key 11.

The input module 10 may transmit “user input data\textcircled{X}first secure key” to the main processor 20 or the processing module 30. The input module 10 may also transfer “user input data\textcircled{X}first secure key” to the processing module 30 via the main processor 20.

The main processor 20 functions to control the overall operation of the portable terminal 100 and may include at least one processor. The main processor 20 may control whether to enter into the secure mode. For example, the main processor 20 may determine that the secure mode may be used or entered into if an application that requires a heightened security is executed, such as a case where the portable terminal 100 accesses a web server of a financial company. If the application requiring the security is executed, the main processor 20 may request the input module 10 to enter into the secure mode. Also, if an input of a reference character(s), an input of a pattern of the user is sensed via a touch panel, a motion of the user, an electronic device, an input of a number or an input pattern using other input devices excluding the touch panel occurs and/or is sensed via a sensor, or if a request to enter into the secure mode is received from an authentication server, the main processor 20 may request the input module 10 to enter into the secure mode.

The processing module 30 is a hardware module that may perform processing in the secure mode. For example, the processing module 30 may be a communication module embedded with a USIM, an IC, and the like. The processing module 30 may be physically connected to the input module 10 or the main processor 20 via the data transmission paths 103 and 105 within the portable terminal 100.

The processing module 30 may store the second secure key 31. Similar to the first secure key 11, the second secure key 31 may be a unique key allocated in production of the processing module 30 or if the processing module 30 is mounted to the portable terminal 100 at a reference time, or only when initially mounted. Also, the second secure key 31 may be received from another module, for example, the input module 10, and be stored in the processing module 30. In the secure mode, the processing module 30 may receive “user input data\textcircled{X}first secure key” and decrypt “user input data\textcircled{X}first secure key” using the second secure key 31. The processing module 30 may perform processing using the decrypted user input data. Here, the processing may be diversified based on a type of an application being currently executed, a type of the input module 10, a type of the processing module 30, an operation state of the portable terminal 100, and the like.

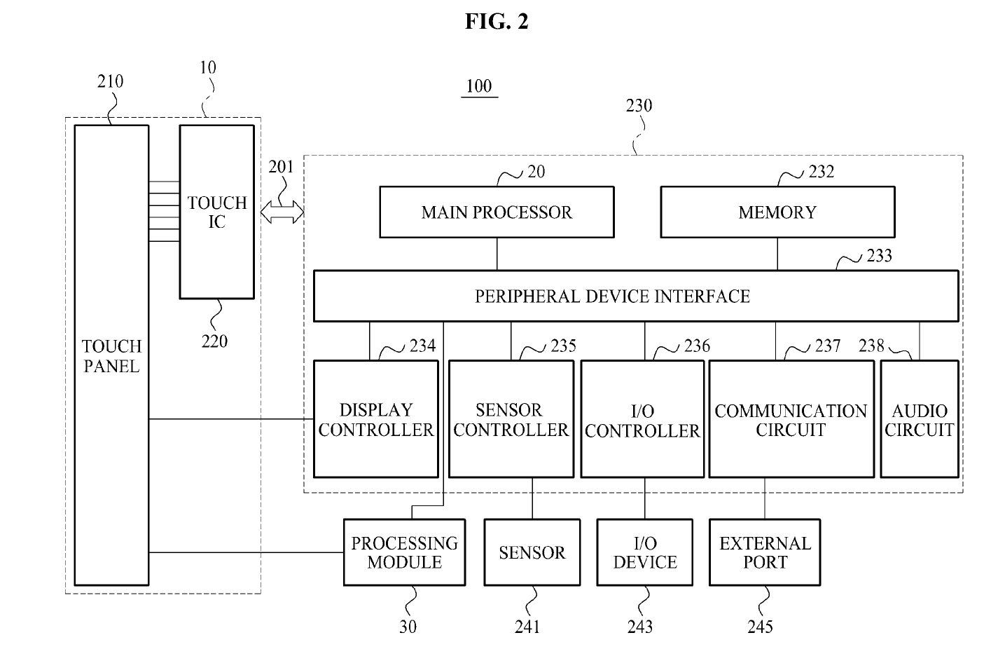

FIG. 2 is a block diagram illustrating a portable terminal according to an exemplary embodiment of the present invention.

Referring to FIG. 2, the portable terminal 100 includes the input module 10, a system 230, the processing module 30, a sensor 241, an input/output (I/O) device 243, and an external port 245.

As shown in FIG. 2, the input module 10 may include a touch panel 210 and a touch IC 220.

The touch panel 210 may provide an input interface for data input of a user. That is, the touch panel 210 may display a keyboard for enabling the user to input a number, a character, a symbol, and the like, using a touch. Here, the keyboard displayed on the touch panel 210 is only an example of the input interface and the input interface may be provided in various forms. The touch panel 210 includes a touch screen. Accordingly, the touch panel 210 may include a touch sensing area and a display area.

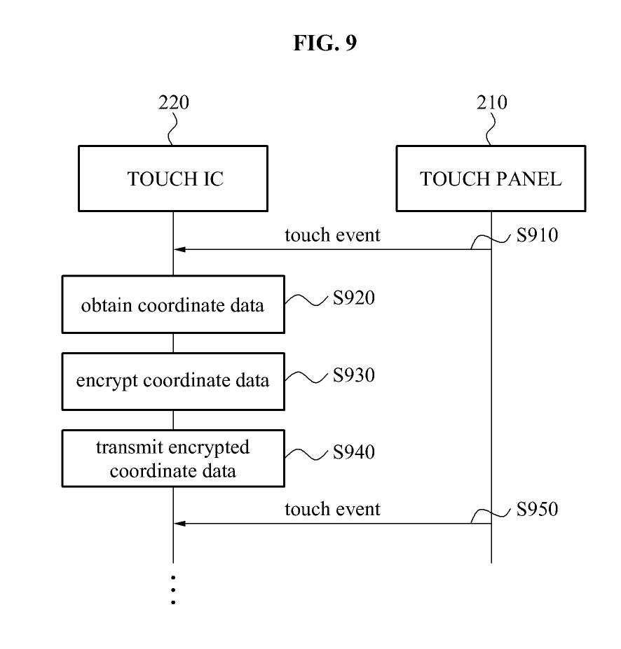

The touch IC 220 may be connected to the touch panel 210 to sense an electrical signal received from the touch panel 210. The touch IC 220 may encrypt data input via the touch panel 210 in the secure mode. In particular, the touch IC 220 may perform encryption exclusively in the secure mode and may not perform encryption in a mode excluding the secure mode. A program to perform various types of encryption algorithms may be embedded in the touch IC 220. The touch IC 220 may convert the electrical signal to data, and may encrypt the converted data. Here, the touch IC 220 may encrypt data using an encryption key. For example, the touch IC 220 may encrypt coordinate data about a location where a touch event occurs. Also, the touch IC 220 may convert the coordinate data to numbers or characters, and may encrypt the numbers or the characters. Encryption may be performed while the touch IC 220 receives a user input in the secure mode. In the secure mode, the encryption performed by the touch IC 220 may be independently performed without intervention of system 230. Examples of an encryption scheme performed at the touch IC 220 will be further described with reference to FIG. 9 through FIG. 11.

The touch IC 220 may block a transfer path 201 of the touch event so that if the touch event occurs in the secure mode, it may not be sensed by a main processor 231.

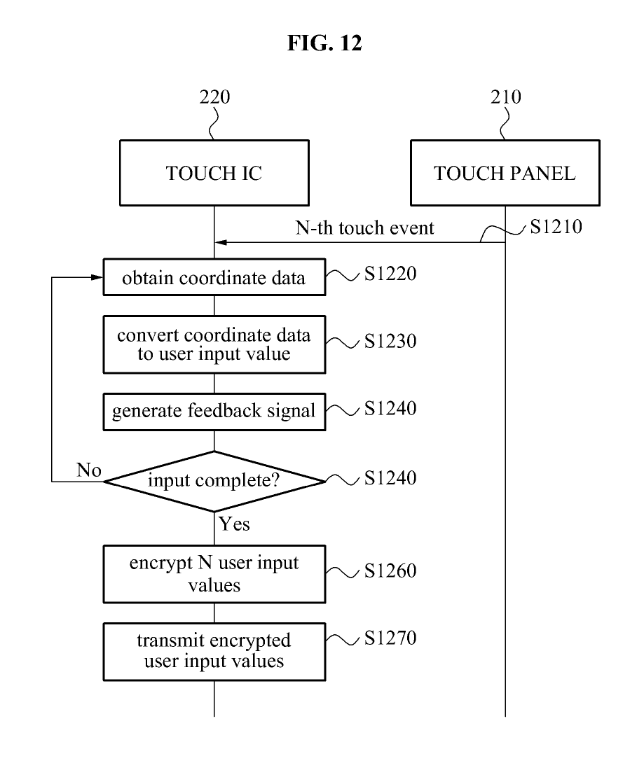

The touch IC 220 may sense an electrical signal received from the touch panel 210 to sense that the touch event has occurred via the input interface. Here, the touch event may occur using a finger of the user; however, a touch event is not limited to and may be due to an instrument such as a stylus. Types of the touch event may include, for example, a gesture, a drag, a tap, a multi-tap, a flick, and the like. If the touch event occurs via the input interface, the touch IC 220 may encrypt coordinate data about an occurrence location of the touch event or a user input value that is converted from the coordinate data to a value corresponding to the user input data, using the first secure key. The user input value will be further described with reference to FIG. 12.

The system 230 includes the main processor 20, a memory 232, a peripheral device interface 233, a display controller 234, a sensor controller 235, an I/O controller 236, a communication circuit 237, and an audio circuit 238. In this disclosure, the term “system 230” or “system” may be used to indicate components excluding the input module 10 and the processing module 30 from among components included in the portable terminal 100. Each of the components included in the system 230 may perform communication via at least one communication bus or signal line. Each of the components may be configured by hardware, software, or combination thereof.

The main processor 20 may signal to change an operation mode of the touch IC 220. The main processor 20 may include a plurality of processors. That is, the main processor 20 may include a plurality of processors, each being configured to perform a plurality of functions, respectively.

The memory 232 may be at least one of: a high-speed random access memory (HSRAM), a magnetic disk, a static random access memory (SRAM), a read only memory (ROM), a flash memory, a non-volatile memory, and the like. The memory 232 may store a software module required for an operation of the portable terminal 100, a set of commands, other various data, and the like.

The peripheral device interface 233 may combine a peripheral input and/or output device of the portable terminal 100 with the main processor 20 and the memory 232.

The display controller 234 may display a visual output, such as information pertaining to the user, by controlling the touch panel 210. For example, the display controller 234 may receive a feedback signal from the touch IC 220 and display a symbol.

The sensor controller 235 may control various sensors 241 included in the portable terminal 100 and receive sensing data from the sensor 241.

The I/O controller 236 may transmit a signal to the I/O device 243 or may receive a signal from the I/O device 243. For example, the I/O device 243 may include a physical button, a light emitting diode (LED), a physical keyboard, a vibration motor, and the like.

The communication circuit 237 may transmit data, received from the touch IC 220, to a server (not shown). The communication circuit 237 may transmit the received data to the server without using the main processor 20. Unlike as shown in FIG. 2, the communication circuit 237 may also be included along with or incorporated in the processing module 30. That is, if the processing module 30 includes the communication module, the communication circuit 237 may also be included in the processing module 30. The communication circuit 237 may include a radio frequency (RF) circuit to convert an electrical signal to an electromagnetic signal or convert the electromagnetic signal to the electrical signal, and to communicate with a communication network and/or other communication networks using the electrical signal. Also, the communication circuit 237 may include at least one circuit element to perform communication of a certain type, such as, Global System for Mobile Communications (GSM), Enhanced Data GSM Environment (EDGE), wideband code division multiple access (W-CDMA), code division multiple access (CDMA), time division multiple access (TDMA), Bluetooth, Institute of Electrical and Electronics Engineers (IEEE) 802.11a, IEEE 802.11b, IEEE 802.11g and/or IEEE 802.11n, and the like, Wireless Fidelity (Wi-Fi), voice over Internet Protocol (VoIP), Wi-MAX, Long Term Evolution (LTE), radio frequency identification (RFID), Near Field Communication (NFC), and the like.

The audio circuit 238 may provide an audio interface between a user and a device 100 using a speaker and/or a microphone.

The external port 245 may be an interface connected to an external device. For example, the external port 245 may include a universal serial bus (USB) port, an external monitor connection port, and the like.

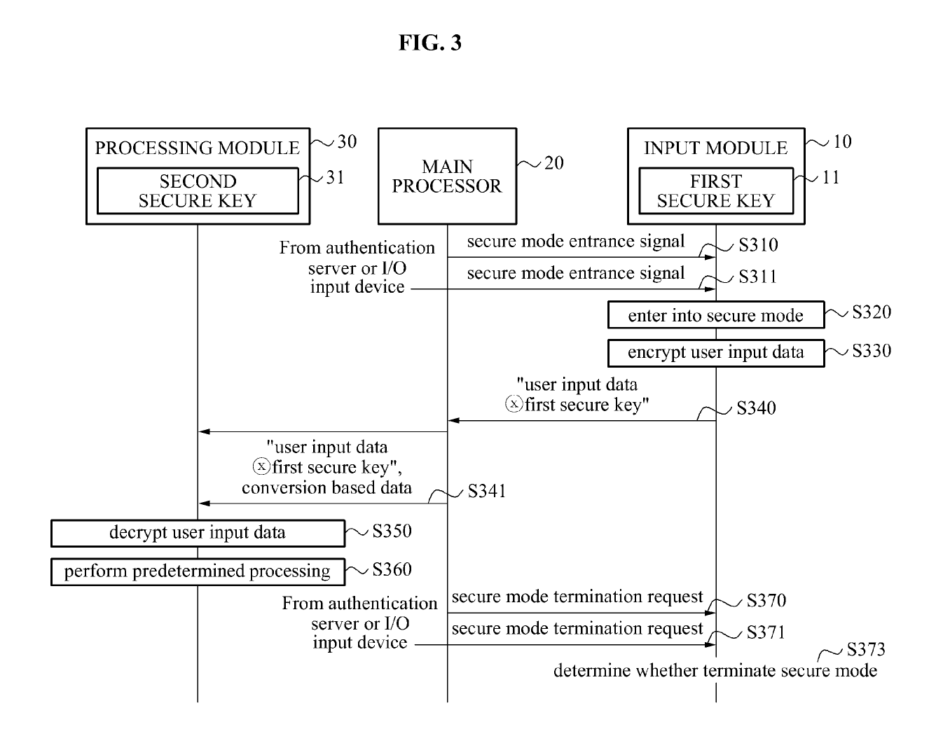

FIG. 3 is a diagram illustrating a method for securing data transmitted between hardware modules according to an exemplary embodiment of the present invention.

Referring to FIG. 3, in operation S310 or S311, an input module 10 may receive a secure mode entrance request signal for requesting entrance into a secure mode. In operation

S311, an indication is made if the secure mode entrance request signal is received at the input module 10 without passing through or using a main processor 20. The secure mode entrance request signal may also be received from an authentication server over a network. In this example, the authentication server makes a request for encrypting an object, and subsequently transmits the encrypted object. For example, a server of a financial company may utilize an authentication server. Also, the authentication server may be a separate server for authenticating the user.

In operation S310, the main processor 20 may transmit, information about an area of the input interface occupying in the touch panel 210 or conversion based data, to the touch IC 220. Here, the conversion based data may be data that is used to convert coordinate data of the touch panel 210 to a user input value corresponding to the user input data. The conversion based data may include “coordinate information allocated to each of number keys, character keys, or symbol keys that are provided via the input interface”. For example, X axis coordinate 0.1 to 1.0 and Y axis coordinate 2.5 to 3.0 may be allocated to a number key “1”, and X axis coordinate 1.01 to 2.0 and Y axis coordinate 2.5 to 3.0 may be allocated to a number key “2”. If coordinate data=(0.8, 2.6), the user input value may be “1”. If coordinate data=(1.5, 2.6), user input value may be “2”.

In operation S320, the input module 10 may enter into the secure mode. The secure mode of the input module 10 may be defined as a mode in which data input from the user is encrypted.

In operation S330, the input module 10 may encrypt the user input data based on the activation of a first secure key 11.

In operation S340, the input module 10 may transmit “user input data\textcircled{X}first secure key” to the main processor 20 or the processing module 30. The “user input data\textcircled{X}first secure key” may be transferred to the processing module 30 via the main processor 20. In operation S341, the main processor 20 may transmit “user input data\textcircled{X}first secure key” and conversion based data to the processing module 30. That is, the main processor 20 may transfer is the conversion based data to the input module 10 or the processing module 30. In this example, if the touch IC 220 encrypts the user input value, the main processor 20 may transfer the conversion based data to the input module 10. If the touch IC 220 encrypts the coordinate data, the main processor 20 may transfer the conversion based data to the processing module 30.

In operation S350, the processing module 30 may receive “user input data\textcircled{X}first secure key” and decrypt “user input data\textcircled{X}first secure key” based on the activation of the second secure key 31.

In operation S360, the processing module 30 may perform processing. Here, the processing may include storing the user input data in the processing module 30, comparing the user input data with pre-stored data, and deliver the comparison result to the main processor 20, verifying a number or character corresponding to the user input data, encrypting the verified number or character using the second secure key 31, and transferring the encrypted number or character to another hardware module of the portable terminal 100. The processing may be associated with an authentication certificate.

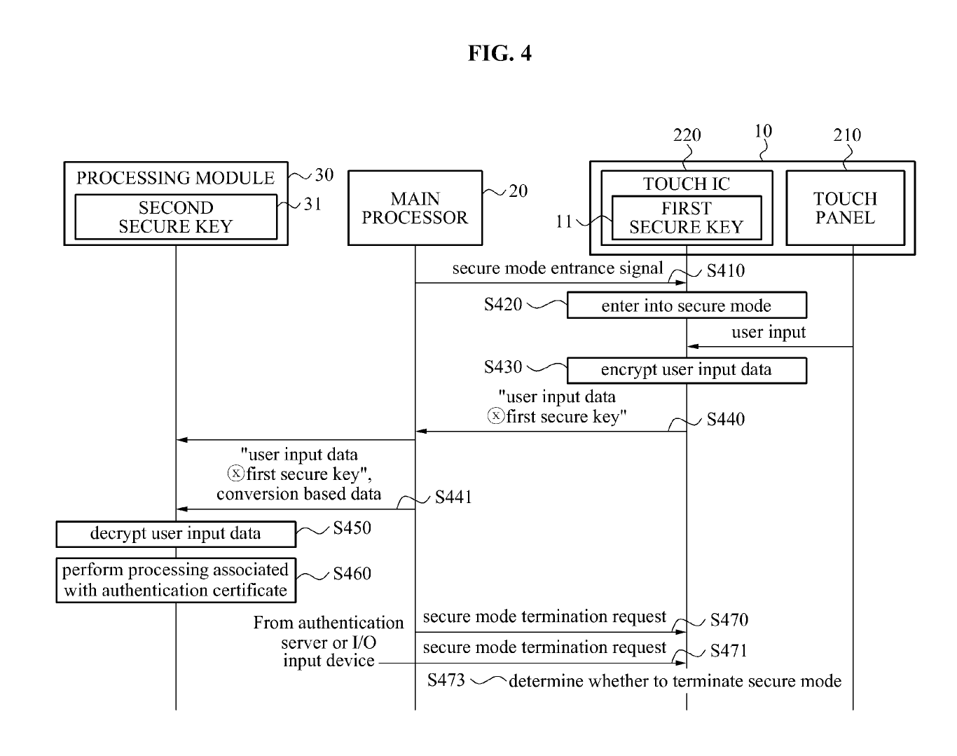

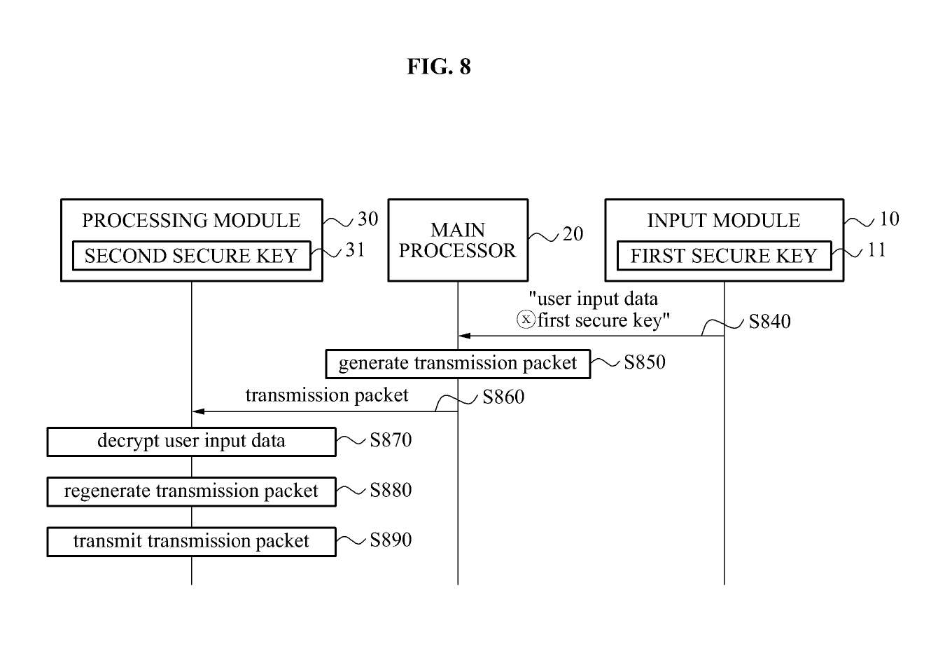

If the processing module 30 corresponds to a communication module, the processing may include operations S870 through S890 of FIG. 8. Various operations of the processing module 30 will be further described with reference to FIG. 4 through FIG. 8.

If a data input of the user is completed in the secure mode, or if the secure mode is to be terminated, the input module 10 may receive a secure mode termination request signal in operation S370 or S371. The secure mode termination request signal is a signal used to request termination of the secure mode. Whether data input of the user is completed may be recognized using various schemes, such as if a password is input, if a number of digits is input, if a ‘complete’ key is touched, if a ‘login’ key is touched, or if a touch and/or event does not occur for a period of time. Thus, if one of the above schemes is implemented, and the condition is met, the data input of the user may be determined to have been completed. Also, like the secure mode entrance request signal, the secure mode termination signal may occur if an input of a number or pattern associated with the user is sensed via the touch panel 210/or another terminal, if a motion of the user or an electronic device is sensed via a sensor, and the like. Also, the secure mode termination signal may be received from the main processor 20 or the authentication server, which is the same as the secure mode entrance request signal.

In operation S373, the input module 10 may determine whether to terminate the secure mode. That is, if data input of the user is determined to be completed in the secure mode, the input module 10 may terminate the secure mode. If the data input of the user is completed, or if the secure mode is terminated, the touch IC 220 of the input module 10 may delete all of the data except for the encrypted data.

FIG. 4 is a diagram illustrating a method for securing data transmitted between hardware modules according to an exemplary embodiment of the present invention.

FIG. 4 shows a case where a password of an authentication certificate is input. The processing module 30 of FIG. 4 may include an IC chip in which a private key of the authentication certificate or a USIM is stored. The private key of the authentication certificate may not be stored in the processing module 30, and once the terminal enters into a secure mode, the private key may be transferred to the processing module 30. For example, the main processor 20 may control the portable terminal 100 to transmit a secure mode entrance request signal to the input module 10 and to transfer the private key of the authentication certificate to the processing module 30.

Referring to FIG. 4, if the password of the authentication certificate is prompted for input, the main processor 20 may transmit a secure mode entrance request signal to the input module 10 in operation S410.

In operation S420, if the secure mode entrance request signal is received, the input module 10 may enter into the secure mode.

If a touch event corresponding to an input of a password, the input module 10 may encrypt coordinate data about an occurrence location of the touch event or a user input value corresponding to the coordinate data using the first secure key 11 in operation S430. The data encrypted in operation S440 may be referred to as data encrypted using the first secure key.

Operations S440 through S450 of FIG. 4 may be the same or similar to operations S340 through S350 of FIG. 3, and therefore a detailed description will be omitted.

In operation S450, the processing module 30 may decrypt the data encrypted using the first secure key, using the second secure key 31.

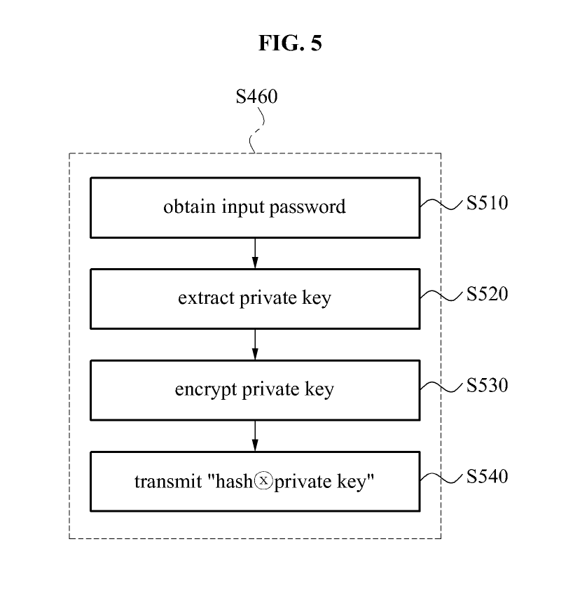

In operation S460, the processing module 30 may perform processing associated with the authentication certificate. The processing may include obtaining a password input from the user based on the data encrypted using the first secure key, using the second secure key 31. An example of processing associated with the authentication certificate is shown in FIG. 5.

Operations S470 through S473 of FIG. 4 may be the same or similar as operations S370 through S373 of FIG. 3, and therefore a detailed description will be omitted.

FIG. 5 is a diagram illustrating a method for processing associated with an authentication certificate according to an exemplary embodiment of the present invention.

Referring to FIG. 5, in operation S510, the processing module 30 may obtain the password input from the user, by decrypting the data encrypted using the first secure key, by using the second secure key 31. A process of obtaining the password input from the user may vary depending on an encryption scheme used by the touch IC 220. For example, if the touch IC 220 encrypts coordinate data, the processing module 30 may convert coordinate data to a user input value and then obtain the password. Also, if the touch IC 220 converts the coordinate data to the user input value and then encrypts the user input value, the processing module 30 may obtain the password by decrypting data encrypted using the first secure key. For example, the processing module 30 may obtain the user input value by decrypting the user input value encrypted using the first secure key” and perform the processing using the obtained user input value. If the password includes various combinations of N characters or numbers, the processing module 30 may receive all of N characters or numbers and then obtain the password. Examples of the encryption scheme of the touch IC 220 will be described with reference to FIG. 9 through FIG. 12.

Referring again to FIG. 5, in operation S520, the processing module 30 may extract private key of the authentication certificate using the obtained password. The private key indicates an encryption key corresponding to a key pair of a public key in a public key based encryption scheme. The private key may be pre-stored in the processing module 30. Also, if the secure mode is activated, the private key may be transferred from the main processor 20 to the processing module 30 and then be stored in the processing module 30. The private key may be stored in the processing module 30 in a format of “private key\textcircled{X}pair key of password”. Accordingly, the processing module 30, at a future time, may obtain the private key by decrypting “private key\textcircled{X}pair key of password”.

Operations S530 and S540 may be used in a general public key based encryption scheme.

In operation S530, the processing module 30 may encrypt a hash value using the private key. The hash value may be the same as a hash value stored in a server. The server may transmit a random number to a portable terminal and the portable terminal may convert the received random number to a hash value. In this example, the server may authenticate the portable terminal by decrypting “hash\textcircled{X}private key” by using the public key, and by comparing the hash value obtained from “hash\textcircled{X}private key” with a pre-stored hash value.

In operation S540, the processing module 30 may transfer “hash\textcircled{X}private key” to the main processor 20 or the communication module.

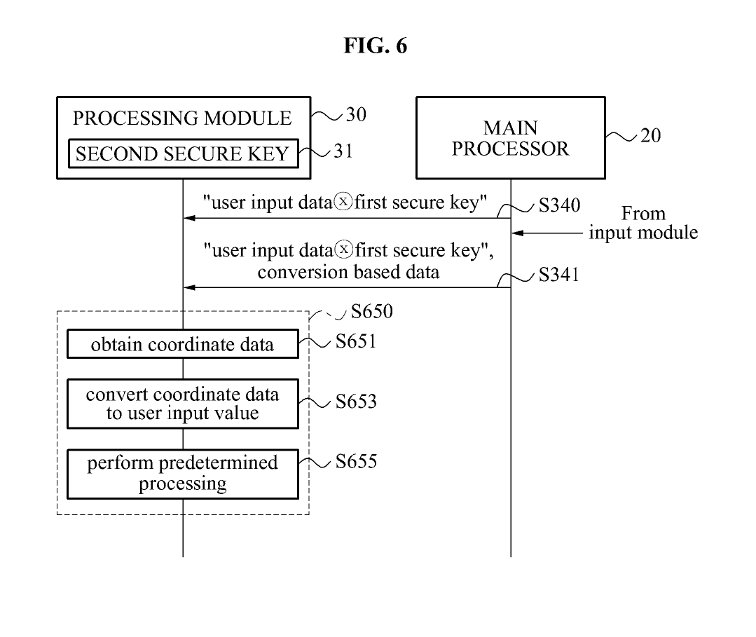

FIG. 6 is a diagram illustrating a method for operating a processing module according to an exemplary embodiment of the present invention.

Referring to FIG. 6, in operation S340, the processing module 30 may receive “user input data\textcircled{X}first secure key”. The processing module 30 may also receive “user input data\textcircled{X}first secure key” and conversion based data from the main processor 20. If the user input data corresponds to data that has not been through a conversion process, the user input data may be converted to a user input value in the processing module 30. In this example, the data may correspond to coordinate data of a touch event.

In operation S650, the processing module 30 may perform processing about “user input data\textcircled{X}first secure key”. The processing module 30 may obtain coordinate data by decrypting the “user input data\textcircled{X}first secure key” using the second secure key 31 in operation S651, convert the obtained coordinate data to the user input value using conversion based data in operation S653, and perform the processing using the user input value in operation S655. In this example, the processing may refer to encrypting a processing result value using the second secure key 31 and transmitting the same to another module in order to transmit the processing result value to the other module using the converted user input value.

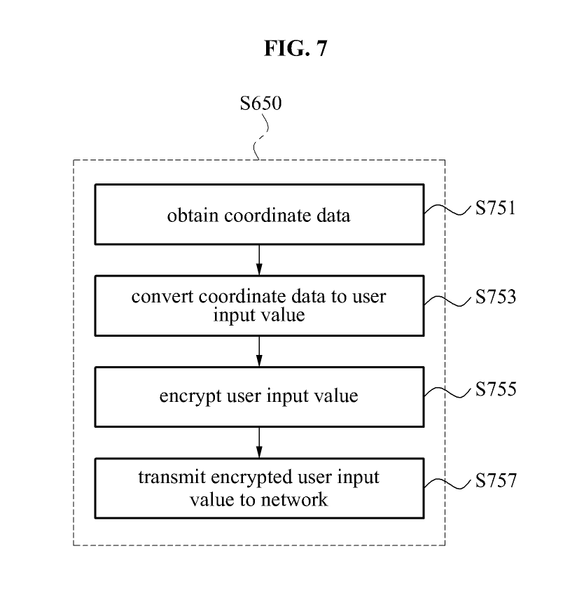

FIG. 7 is a diagram illustrating a method for performing processing according to an exemplary embodiment of the present invention.

Referring to FIG. 7, the processing module 30 may obtain coordinate data by decrypting “user input data\textcircled{X}first secure key” by using the second secure key 31 in operation S751, convert the obtained coordinate data to the user input value using conversion based data in operation S753, encrypt the user input value using the second secure key 31 in operation S755, and transmit the encrypted user input value via a network in operation S757.

FIG. 8 is a diagram illustrating a method of transmitting a packet according to an exemplary embodiment of the present invention.

FIG. 8 shows an example in which the processing module 30 corresponds to a communication module. The communication module may perform communication of, for example, GSM, EDGE, W-CDMA, CDMA, TDMA, Bluetooth, 802.11a, IEEE 802.11b, IEEE 802.11g, and/or IEEE 802.11n, and the like, Wi-Fi, VoIP, Wi-MAX, LTE, RFID, NFC, and the like. Also, the communication module may store the second secure key 31.

Referring to FIG. 8, in operation S840, the main processor 20 may receive “user input data\textcircled{X}first secure key” from the input module 10.

In operation S850, the main processor 20 may generate a transmission packet including “user input data\textcircled{X}first secure key”.

In operation S860, the main processor 20 may transmit the transmission packet to the communication module. In this example, the communication module may also receive the transmission packet and the conversion based data from the main processor 20.

In operation S870, the communication module may decrypt “user input data\textcircled{X}first secure key”. For example, the communication module may extract “user input data\textcircled{X}first secure key” from the transmission packet and obtain the user input data by decrypting the “user input data\textcircled{X}first secure key”.

In operation S880, the communication module may regenerate the transmission packet using the decrypted user input data. The regenerated packet may include a field added to a physical layer of the transmission packet.

In operation S890, the communication module may transmit the regenerated transmission packet to an external network.

FIG. 9 is a diagram illustrating a secure mode operation of a touch integrated circuit (IC) according to an exemplary embodiment of the present invention.

Referring to FIG. 9, if a touch event occurs in operation S910, the touch IC 220 may obtain coordinate data about an occurrence location of the touch event in operation S920. The coordinate data may have an X axis coordinate and a Y axis coordinate, corresponding to an exact location of the touch panel 210. The touch IC 220 may calculate the coordinate data based on a change in a capacitance, an amount of current, and the like, by using a sensor. The touch IC 220 may calculate the coordinate data using a change in an electrical resistance of the touch sensor and the like. That is, the touch sensor may be configured using various schemes, such as a capacitive type, a decompression type, and the like.

In operation S930, the touch IC 220 may encrypt the coordinate data using the first secure key 11.

In operation S940, the touch IC 220 may transmit the encrypted coordinate data to the processing module 30 or the main processor 20.

The touch IC 220 may perform an encryption corresponding to a touch event. For example, if a new touch event occurs in operation S950, the touch IC 220 may encrypt coordinate data about the new touch event. Also, every time the touch event occurs, the encrypted coordinate data may be transmitted to the main processor 20 or the processing module 30.

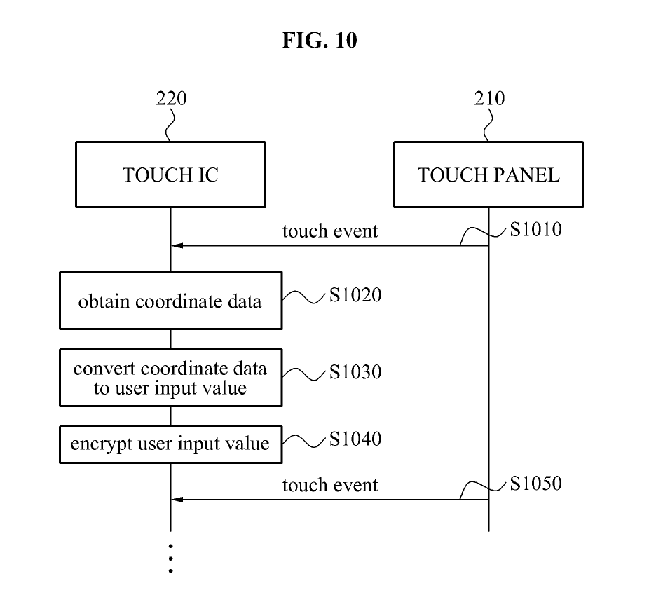

FIG. 10 is a diagram illustrating a secure mode operation of a touch IC according to an exemplary embodiment of the present invention.

If a touch event occurs in operation S1010, the touch IC 220 may obtain coordinate data corresponding to a location of the touch event, in operation S1020.

In operation S1030, the touch IC 220 may convert the coordinate data to a user input value corresponding to user input data.

In operation S1040, the touch IC 220 may encrypt the user input value using the first secure key 11. Every time the touch event occurs, the touch IC 220 may perform encryption. For example, if a new touch event occurs in operation S1050, the touch IC 220 may encrypt a user input value corresponding to the new touch event.

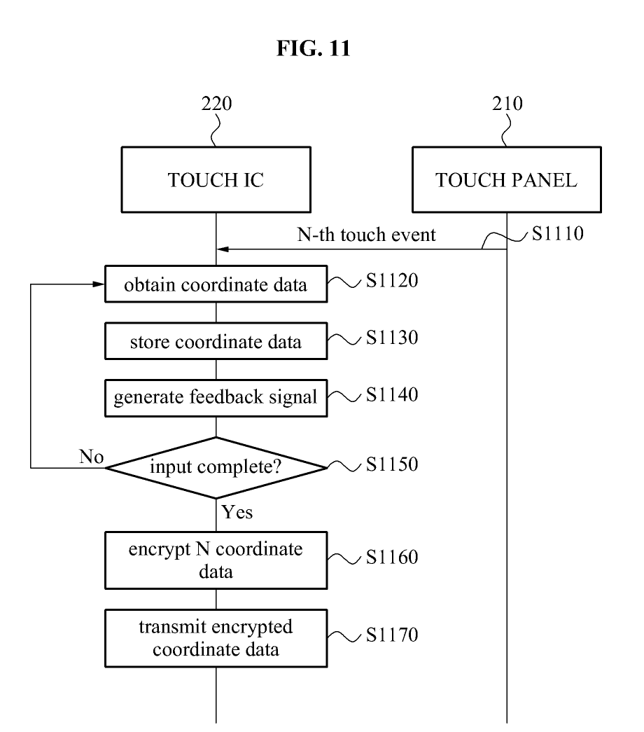

FIG. 11 is a diagram illustrating a secure mode operation of a touch IC according to an exemplary embodiment of the present invention.

Referring to FIG. 11, a determination of whether an N-th touch event occurs is made, in operation S1110. After which, if the touch event occurs, the touch IC 220 may obtain coordinate data corresponding to the location of the touch event in operation S1120. In this example, the N-th touch event indicates a number of N, where N is an integer greater than or equal to 1, touch events occurring after entering into the secure mode. Thus, if the N-th touch event occurs, it indicates that N touch events have occurred after entering into the secure mode.

In operation S1130, the touch IC 220 may store N pieces of coordinate data about respective corresponding occurrence locations of N touch events. The N pieces of coordinate data may be stored in order to encrypt all of the user input data after data input is completed.

In operation S1140, the touch IC 220 may generate a feedback signal indicating that a touch is sensed with respect to each touch event, and may provide the feedback signal to an application being executed or a display controller. For example, the feedback signal may indicate a random or reference value and be displayed as “*”.

In operation S1150, the touch IC 220 may determine whether data input of the user is completed. If the data input of the user is not completed, the touch IC 220 may perform operation S1120 depending on whether a new touch event has occurred. Whether data input of the user is completed may be recognized using various schemes. For example, the completion may be denoted with various schemes, such as if a password is input, if a number of digits is input, if a ‘complete’ key is touched, if a ‘login’ key is touched, or if a touch event does not occur over a period of time, the data input of the user may be determined to have been completed.

If the data input of the user is completed, the touch IC 220 may encrypt the stored N pieces of coordinate data using the first secure key 11, in operation S1160.

In operation S1170, the touch IC 220 may transmit the encrypted coordinate data to the processing module 30 or the main processor 20.

FIG. 12 is a diagram illustrating a secure mode operation of a touch IC according to an exemplary embodiment of the present invention.

Referring to FIG. 12, if an N-th touch event occurs in operation S1210, the touch IC 220 may obtain coordinate data about an occurrence location of the touch event, in operation S1220.

In operation S1230, the touch IC 220 may convert the coordinate data to a user input value corresponding to user input data.

In operation S1240, the touch IC 220 may generate a feedback signal indicating that a touch is sensed with respect to each touch event and provide the feedback signal to an application being executed or a display controller. For example, the feedback signal may be a random value and be displayed as “*”.

In operation S1250, the touch IC 220 may determine whether data input of the user is completed. If the data input of the user is not completed, the touch IC 220 may perform operation S1220 again, based on the occurrence of a new touch event. Whether a data input of the user is completed may be recognized using various schemes. These schemes may be the same or similar to those described with FIG. 11.

If the data input of the user is completed, the touch IC 220 may encrypt the stored N user input values about respective corresponding N touches events. Here, N denotes an integer greater than or equal to “1”. That is, if the touch IC 220 recognizes that the data input of the user is completed in operation S1260, the touch IC 220 may encrypt the N user input values using the second secure key 31.

In operation S1270, the touch IC 220 may transmit the encrypted user input values to the processing module 30 or the main processor 20.

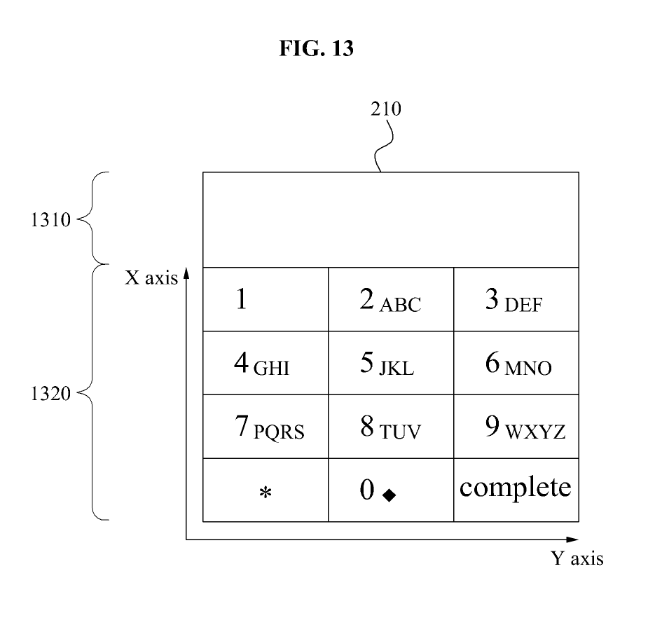

FIG. 13 is a diagram illustrating a method for displaying an input interface on a touch panel according to an exemplary embodiment.

Referring to FIG. 13, the input interface corresponds to a number keyboard and may be displayed on a partial area 1320 of the touch panel 210. A symbol, for example, “*” and the like may be displayed on an area 1310 where the input interface is not displayed, based on a feedback signal. Also, conversion based data may include coordinate data of areas 1310 and 1320. In the example of FIG. 13, if the user touches “1”, a user input value is “1” and coordinate data is a coordinate value of X and Y axes where the touch has occurred on the area 1320.

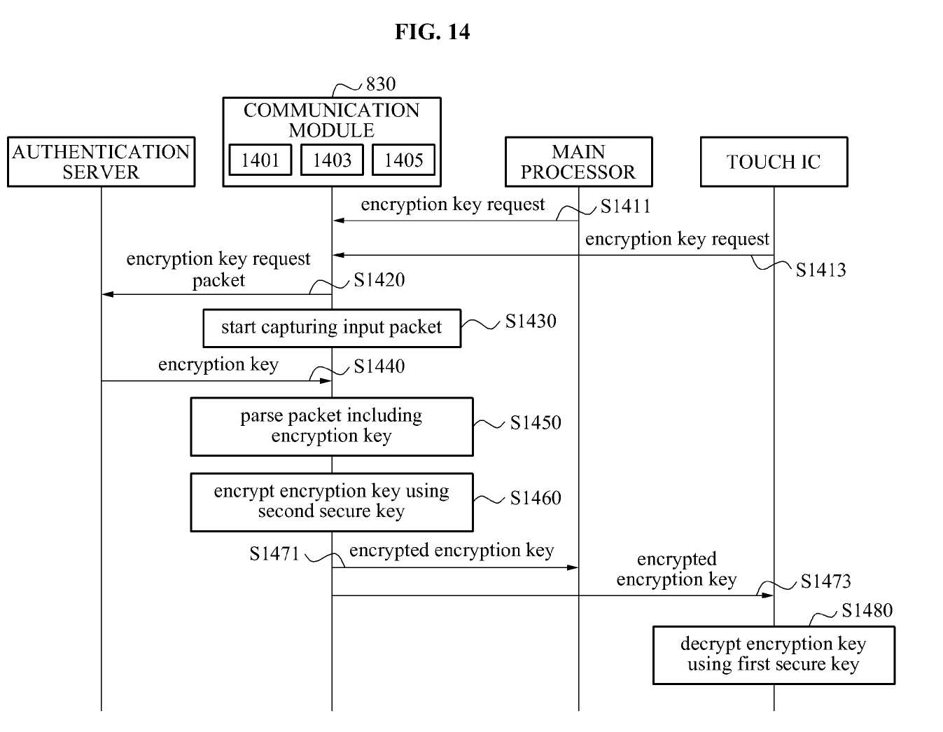

FIG. 14 is a diagram illustrating a method for obtaining an encryption key according to an exemplary embodiment of the present invention.

In FIG. 14, the encryption key may be an authentication certificate, a private key, a general encryption key, a random number, a hash value, and the like. That is, the encryption key of FIG. 14 indicates an encryption key that is distinguished from a first secure key and a second secure key. Thus, data may be obtained instead with or without the use of the encryption key, according to a method of FIG. 14. If the data is obtained without using the encryption key, a touch IC of FIG. 14 may be replaced with a display module, a USIM chip, and the like.

Referring to FIG. 14, a communication module 830 may include a unique key storage unit 1401, a parsing unit 1403, and an encryption unit 1405.

The unique key storage unit 1401 may store the second secure key.

In operation S1411 or S1413, a main processor or a touch IC may transmit an encryption key request message to the communication module 830.

In operation S1420, the communication module 830 may generate an encryption key request packet and transmit the encryption key request packet to an authentication server.

In operation S1430, the communication module 830 may start capturing a packet received from the authentication server. Here, capturing of the packet may encompass verifying whether a packet that includes the encryption key is received by decoding only a header of the received packet. Also, capturing of the packet may be performed if a period of time elapses after transmitting the encryption key request packet to the authentication server.

In operation S1440, the authentication server may generate a new encryption key or may transmit the pre-stored encryption key to the communication module 830.

In operation S1450, the parsing unit 1403 of the communication module 830 may parse the encryption key from the packet including the encryption key among packets received from the authentication server, and may transfer the parsed encryption key to the encryption unit 1405.

In operation S1460, the encryption unit 1405 may encrypt the parsed encryption key using the second secure key stored in the unique key storage unit 1401.

In operation S1473, the encryption unit 1405 may transfer the encryption key encrypted using the second secure key to the touch IC. In operation S1471, “second secure key\textcircled{X}encryption key” may be transferred to the touch IC via a main processor.

In operation S1480, the touch IC may receive “second secure key\textcircled{X}encryption key” from the communication module 830 and decrypt “second secure key\textcircled{X}encryption key” using the first secure key.

According to exemplary embodiments of the present invention, it may be possible to protect important information input from a user.

Also, according to exemplary embodiments of the present invention, it may be possible to reinforce a security of a portable terminal by encrypting, by a touch integrated circuit (IC), information input via a touch screen or a touch panel.

Also, according to exemplary embodiments of the present invention, it may be possible to reinforce a security of a portable terminal by encrypting data transmitted between hardware modules of the portable terminal.

Also, according to exemplary embodiments of the present invention, it may be possible to significantly decrease a personal information leakage that may occur while inputting an identifier (ID), a password, and the like of a user.

The exemplary embodiments of the present invention may be recorded in a transitory or non-transitory computer-readable media including program instructions to implement various operations embodied by a computer. The media may also include, alone or in combination with the program instructions, data files, data structures, and the like. The media and program instructions may be those specially designed and constructed for the purposes of the exemplary embodiments of the present invention, or they may be of the kind well-known and available to those having skill in the computer software arts.

It will be apparent to those skilled in the art that various modifications and variation can be made in the present invention without departing from the spirit or scope of the invention. Thus, it is intended that the present invention cover the modifications and variations of this invention provided they come within the scope of the appended claims and their equivalents.

What is claimed is:

1. A portable terminal, comprising:
an input module to receive an input and to encrypt the input based on a mode of operation of the portable terminal;
a main processor to control the portable terminal and to determine the mode as a secure mode or a non-secure mode; and
a processing module to decrypt the input in the secure mode,
wherein the processing module connects to the main processor and the input module, and provides the decrypted input to the main processor or the input module.

2. The terminal according to claim 1, wherein the input is a touch and the input module encrypts the input according to a coordinate of the touch.

3. The terminal according to claim 2, wherein:
the input module encrypts the input with a first key,
the processing module decrypts the input with a second key, and
the first key and the second key form a pair.

4. The terminal according to claim 1, wherein the main processor determines that the mode is the secure mode based on a security level of an application being executed.

5. The terminal according to claim 1, wherein the main processor determines that the mode is the non-secure mode based on the input being a reference pattern.

6. A method for securing data for a portable terminal, the method comprising:
receiving an input and encrypting the input based on a mode, in an input module;
controlling the portable terminal and determine the mode as a secure mode or a non-secure mode, in a main processor;
decrypting the input in the secure mode, in a processor module connected to the main processor; and
providing the decrypted input to the main processor or the input module.

7. The method according to claim 6, further comprising encrypting a coordinate of the input, the input being a touch.

8. The method according to claim 7, wherein:
the input module encrypts the input with a first key,
the processing module decrypts the input with a second key, and
the first key and the second key form a pair.

9. The method according to claim 6, further comprising:
executing an application based on a security level of the application; and
based on the execution, determining that the mode is the secure mode.

10. The method according to claim 9, wherein the main processor determines that the mode is the non-secure mode based on the input being a reference pattern.

11. The method according to claim 6, further comprising transmitting the encrypted data to the processing module from the main processor.

12. The method according to claim 6, further comprising transmitting the encrypted data as a packet to the processing module from the main processor via a network.

13. The method according to claim 12, further comprising:
regenerating the packet in the processing module; and
transmitting the packet to the main processor from the processing module.

14. A portable terminal, comprising:
an input module to receive an input and to encrypt the input based on a mode of operation of the portable terminal;
a main processor to control the portable terminal, to decrypt the input based on an encryption key, and to determine the mode as a secure mode or a non-secure mode; and
an authentication server to receive an encryption key request and to provide the encryption key to the main processor,
wherein the authentication server connects to the main processor and the input module.

15. The terminal according to claim 14, wherein the input is a touch and the input module encrypts the input according to a coordinate of the touch.

16. The terminal according to claim 15, wherein the input module makes the request for the encryption key.

17. The terminal according to claim 15, wherein the main processor makes the request for the encryption key.

18. The terminal according to claim 15, wherein the main processor communicates to a processing module via a network, and the main processor transmits the encrypted data to the processing module.

19. The terminal according to claim 15, wherein the main processor communicates to a processing module via a network, and the main processor transmits the encrypted data as a packet to the processing module.

20. The terminal according to claim 19, wherein the processing module regenerates the packet and transmits the packet to the main processor.
